(19) United States
(12) Patent Application Publication
(10) Pub. No.: US 2006/0201581 A1
(43) Pub. Date: Sep. 14, 2006

(54) Timber fastener and method of manufacturing and employing the same

(76) Inventors: Richard Belinda, Westfield, MA (US); Tad A. Weiss, Westhampton, MA (US)

Correspondence Address: ALIX YALE & RISTAS LLP, 750 MAIN STREET, SUITE 1400, HARTFORD, CT, 06103, US

(21) Appl. No.: 11/187,042

(22) Filed: Jul. 21, 2005

Related U.S. Application Data
(60) Provisional application No. 60/660,289, filed on Mar. 10, 2005.

(51) Int. Cl. B27F 7/00

(52) U.S. Cl. 144/344

(57) ABSTRACT

A timber fastener and method of manufacturing and utilizing the same wherein the fastener includes a shaft having a center axis, a head end, and a tip end. The shaft has a first threaded portion proximate the tip end and a second threaded portion proximate the head end and having off-timed threads in relation to the first threaded portion. The off-timing of the second threaded portion threads results from such structural features as: a pre-selected defined distance separating the first and second threaded portions; different thread and flank angles; different thread pitches; and/or a different thread direction relative to the first threaded portion.

### CROSS-REFERENCE TO RELATED APPLICATION

This application claims the priority of U.S. Provisional Application 60/660,289 filed on Mar. 10, 2005.

### FIELD OF THE INVENTION

This invention generally relates to fastening of wood based construction materials. In particular, the invention relates to a fastener and the fastening together of wooden lumber, beams, and log members.

### BACKGROUND OF THE INVENTION

Use of substantial wooden timbers, such as logs, beams, or lumber, for the construction of habitable structures is an ancient practice. Historically, the creation of these ancient structures included the stacking of notched logs such that walls were formed. The logs were often used in a virtually unprocessed state and as such they possessed a substantially cylindrical configuration. This cylindrical configuration resulted in the stacked log wall having a limited contact interface along the length of adjacent logs. This limited contact interface often resulted in gaps between the logs through which wind, water, and pests could easily enter the structure—much to the dismay of the occupants. In response, the builders of these structures started using chinking material along the length of the limited contact interface. This chinking material typically included mud and plant materials. As log processing machinery and equipment was developed and became readily accessible, logs were often planed or sawn such that their contact interface became much more substantial. This was done by forming flat surfaces along the length of the logs. In addition, material was often placed between the logs, on the flat surfaces, in order to better seal the contact interface. With the advent of modern building techniques and materials, stacked timber structures were displaced to a large extent.

In the past few decades, there has been a resurgence in the desire to build habitable stacked timber structures due to their aesthetic uniqueness. For example, many people feel that the stacked timber structures, commonly referred to as log buildings, were more appropriate in secluded and forested building locations. Along with this newly revived desire for log building came several undesirable consequences. The most daunting of these undesirable consequences was attributable to the settling of the log structures. This settling is due to the relatively compressible nature of the logs. This compressibility results in a reduction of overall height of the stacked log wall over a period of time. This loss of height is commonly referred to as settling.

Settling was quickly identified as a consequence that seemed to be in direct opposition to the use of modern building conveniences. For example, electrical wiring, plumbing, and finished interior wall and ceiling surfaces were quickly damaged or destroyed by the settling. Efforts to limit this settling were the subject of much study and resulted in the use of, for example, low moisture content logs and alternative lumber processing. These solutions were typically directed toward reducing the shrinkage due to equilibrium moisture content, and distortion of the logs due to improper log selection. In addition, various grooves and gaskets were developed in an attempt to better seal the log interfaces and to reduce the settling. For example, it was identified that kerfing could control log checking or cracking that can lead to settling. However, settling in an amount of at least 6% was often considered unavoidable. Such settling is equivalent to a height reduction of approximately ¾ inches per foot of wall height.

A conventional attempt to avoid or substantially reduce the settling is to pre-compress the log walls. Conventional pre-compression of log walls is accomplished in several ways. One common way is by compressing the entire wall or substantial portions of the wall with, for example, a through rod technique. The through rod technique typically utilizes a partially or fully threaded rod that extends through several logs. A washer and nut is located on either end off the threaded rod such that, as the nut is turned, the threaded rod is tensioned and the wall between the nut ends is compressed. This technique requires that the logs have a passage drilled through them which allows for the threaded rod to pass substantially freely. This drilling is extremely labor intensive and technically challenging.

Another common conventional way of pre-compressing the logs is to use a paired log compression technique. This technique involves using, for example a spike or lag bolt having a head and a fastening portion. The spike or lag bolt is typically used in conjunction with a bearing plate assembly, for example, a washer or compression element. In use, the spike or lag bolt is inserted through the bearing plate into a drilled passage in an upper log such that a fastening end of the spike or lag bolt can enter a lower log and such that the head bears against the bearing plate. As the spike or lag bolt is engaged with the lower log, the portion of the spike or lag bolt passing through the drilled passage in the upper log is tensioned and the upper log is thereby compressed.

Conventionally the paired log compression technique is logistically less complex than the through rod technique since only the drilled passage in the upper log is required instead of a drilled passage through multiple logs. However, the paired log technique still requires the time consuming and technically challenging drilling required to form the passage. In addition, both the through rod and paired log techniques utilize rods or shafts that are susceptible to stretching due to the relatively great length over which they are tensioned. For example, in the paired log technique the spike or lag bolt portion passing through the upper log may be tens of inches long. Furthermore, both the through rod and paired log techniques concentrate compressive force at or near the outer surface of a log which may induce checking or cracking of that log.

### SUMMARY OF THE INVENTION

Briefly stated, the present invention in a preferred form is a timber fastener that includes a shaft having a center axis, a head end, and an opposite tip end. The shaft has a first threaded portion proximate the tip end and a second threaded portion having off-timed threads proximate the head end. The off-timing of the second threaded portion threads results from such structural features as: the selectively defined distance separating the first and second threaded portions; different thread and flank angles; different thread pitches; and/or a different thread direction relative to the first threaded portion.

Intermediate the first and second threaded portions is a non-threaded tensioned portion. The timber fastener includes a head at the head end of the shaft. The head can include a tool engagement portion, an angular neck portion, and/or a lip portion that extends in a substantial lateral orientation to the center axis of the shaft.

The opposite end of the timber fastener includes a tip which is configured to penetrate into a timber surface and which advantageously allows the first threaded portion to engage the timber material.

The invention in a preferred form also includes a method of manufacturing a timber fastener wherein the fastener, which includes a shaft with a first threaded portion proximate the tip end and a second threaded portion having off-timed threads proximate a head end, is produced by forming the first threaded portion and the second threaded portion in two successive threading operations. The first and second threading operations result in a second threaded portion being off-timed relative to the first threaded portion. The off-timing of the second threaded portion threads may be achieved by roll forming the second portion threads with threading plates that are configured and/or positioned to form the off-timed threading.

The invention in a preferred form further includes a method of utilizing a timber fastener which includes a shaft with a first threaded portion proximate the tip end and a second threaded portion having off-timed threads proximate a head end of the shaft and a non-threaded tensioned portion intermediate the first and second threaded portions. In use, an upper and a lower log are positioned adjacent one another. The tip end of the timber fastener is then contacted with the upper log. The timber fastener is then rotated or torqued with a tool that is operatively engaged with the head end of the shaft. The rotating first portion penetrates through the upper log into the lower log. At or about the time the rotating first threaded portion first enters the lower log, the rotating first portion draws, in sequence, the intermediate tensioning portion and second threaded portion into the interior of the upper log. As the second threaded portion with the off-timed threads contacts the upper log, a tensioning of the fastener tensioned portion begins. Rotation of the timber fastener effectively terminates when the tensioned portion is positioned in a portion of the upper log and a portion of the lower log.

An object of the invention is to provide a new and improved fastener, method of manufacturing a fastener, and a method of using a fastener that are advantageously adapted for the construction of log buildings.

An object of the invention is to provide a relatively low cost, efficient, and reliable timber fastener, method of manufacturing a fastener, and a method of using a fastener for use in the construction of log buildings and the like.

A further object of the invention is to produce a timber fastener for use in joinably pre-compressing a pair of logs.

### BRIEF DESCRIPTIONS OF THE DRAWINGS

Other objects and advantages of the invention will be evident to one of ordinary skill in the art from the following detailed description with reference to the accompanying drawings, in which:

FIG. 1 shows a side elevational view, partly in diagramatic form, of a timber fastener having a first threaded portion, a second threaded portion with off-timed threads, and a tensioned portion associated with an upper and a lower log consistent with the present invention.

FIG. 2 is a block diagram of steps in forming a timber fastener consistent with the present invention.

FIG. 3 is a block diagram of steps of utilizing a timber fastener with a pair of logs consistent with the present invention.

FIG. 4 is a diagrammatic view which shows the spatial relationship between a pair of threaded portions having similar threads, and an intervening tensioned portion consistent with the present invention.

FIG. 5 is a diagrammatic view which shows the spatial relationship between a pair of threaded portions having dissimilar threads, and an intervening tensioned portion consistent with the present invention.

FIG. 6 is a diagrammatic view which shows the relationship between a pair of threaded portions in one relative configuration with regard to a distance between the threaded portions and their relationship with a timber material consistent with the present invention.

FIG. 7 is a diagrammatic view which shows the relationship between a pair of threaded portions in another relative configuration with regard to a distance between the threaded portions and their relationship with a timber material consistent with the present invention.

FIG. 8 shows a side view, partly broken away and partly in diagram form, of a timber fastener having a head, a first threaded portion, a second threaded portion with off-timed threads, and a dimensioned tensioned portion consistent with the present invention.

FIG. 8A is a cut-away view of a timber fastener head and associated washer consistent with the present invention.

FIGS. 9 A-E depict timber fasteners of different dimensions associated with upper and lower logs of different diameters consistent with the present invention.

### DETAILED DESCRIPTION OF THE PREFERRED EMBODIMENTS

With reference to the drawings wherein like numerals represent like parts throughout the several figures, a timber fastener in accordance with the present invention is generally designated by the numeral 10.

In one embodiment of the present invention, the timber fastener 10 includes a shaft 12 having a center axis 14, a head end 16, and an opposite tip end 18. The shaft 12 has a first threaded portion 20 having threads 26 proximate the tip end 18 and a second threaded portion 22 having off-timed threads 24 proximate the head end 16.

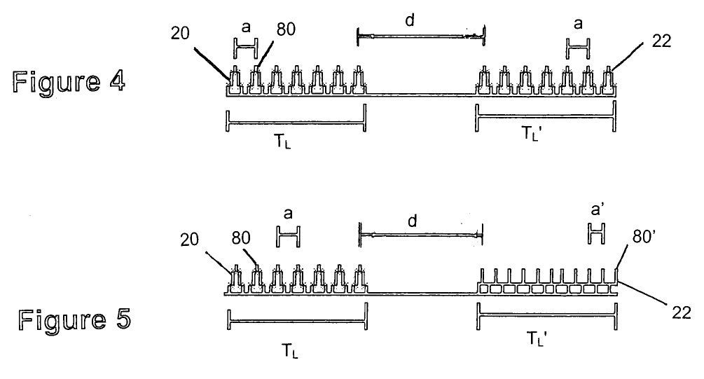

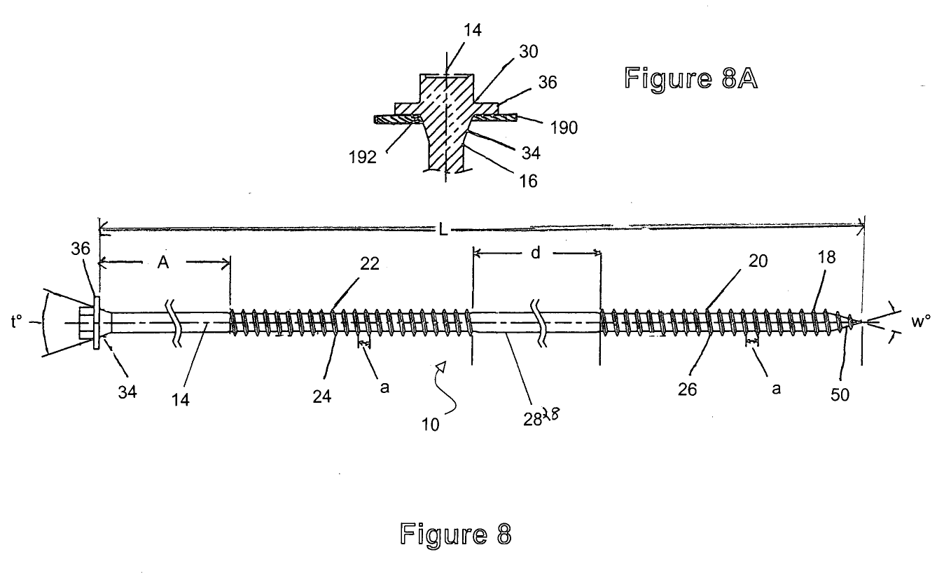

The off-timing relationship between the first threaded portion 20 and the second threaded portion 22, in a preferred form, is defined by a selected distance between the first threaded portion 20, having a length T_{L}, and the second threaded portion 22, having a length T_{L}′. For example, as shown in FIGS. 4 and 8, the distance between the threaded portions 20, 22, “d”, is defined by d=x(a)+y; where “a” is a distance between adjacent thread crests 80, “x” is a whole number other than 0, and “y” is a value greater than 0 and less than a. Stated, differently d≠na where n is a positive integer.

This relationship of the first threaded portion 20 and the second threaded portion 22 results in a timber fastener 10 which will, for example as shown in FIG. 7, engage a timber material 100 such that the first threaded portion 20 creates a thread pathway 88 having timber material crests 90. The timber material crests 90 have a distance between adjacent timber material crests 90 which is substantially equal to the distance “a” between adjacent thread crests 80 of, for example, the first threaded portion 20. The second threaded portion 22 will engaged the thread pathway 88 such that a thread crest 80 of the second threaded portion 22 contacts the thread pathway 88 at a location between the timber material crest 90 and a timber material root 91. This contact results in a deformation of the timber pathway 88 by the second threaded portion 22. In operation, this deformation of the timber pathway 88 causes the timber material 100 in contact with the second threaded portion 22 to be compressed in the direction of the first threaded portion 20.

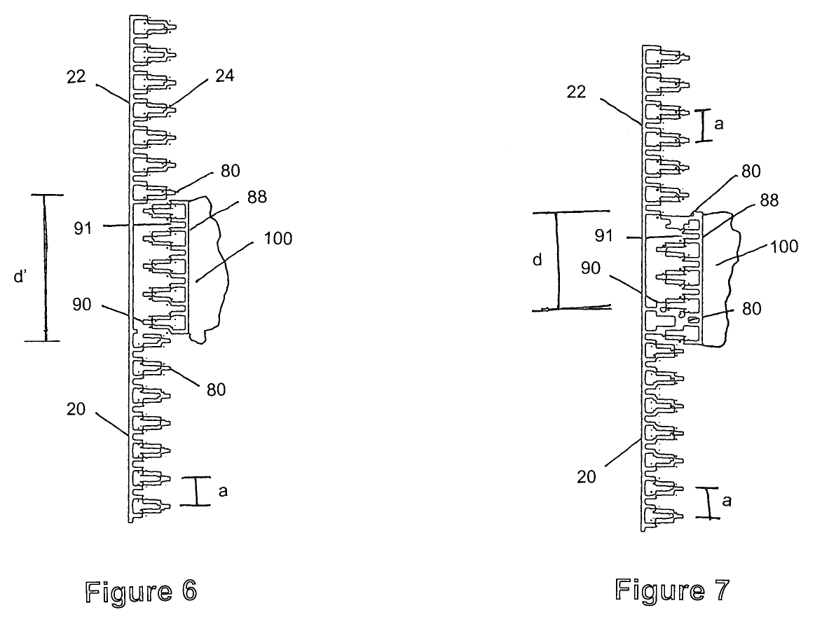

It should be noted, as shown in FIG. 6, that a first thread crest 80 of the second threaded portion 22 and the timber material root 91 may initially associate with one another as a threaded pair due to the distance d′ being equal to a whole number multiple of the thread distance “a”; however, the subsequent thread crests 80 of the second threaded portion 22 may engage with, for example, the timber material crest 90, due to the second threaded portion threads 24 having a different pitch angle, flank angle, and/or thread angle.

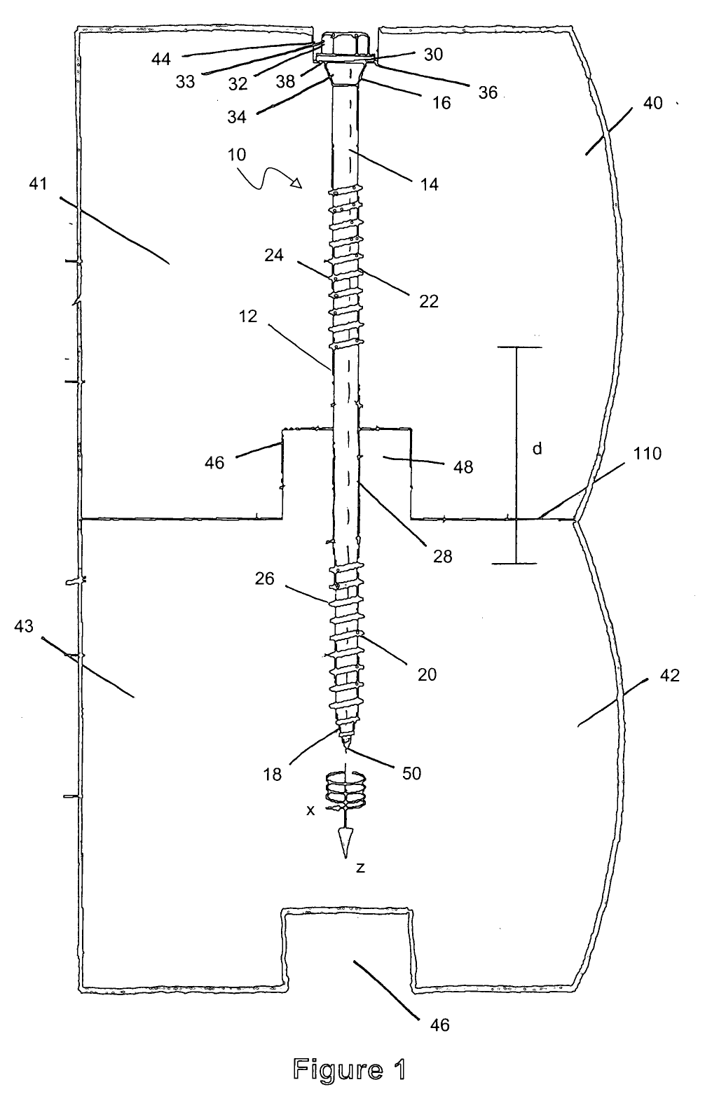

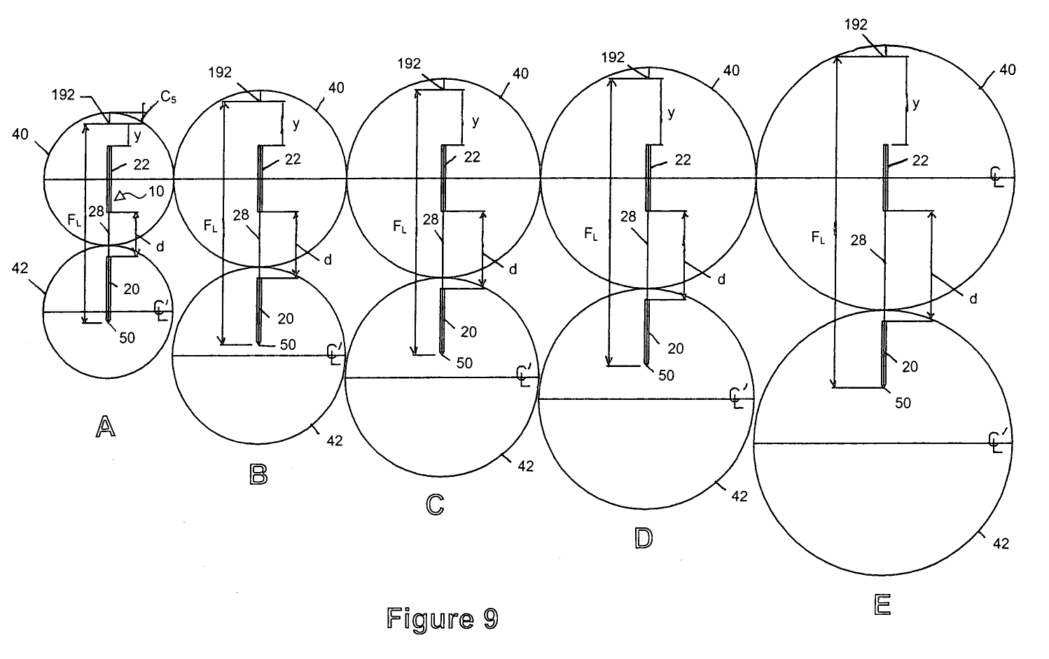

In one embodiment of the present invention, as shown in FIGS. 1 and 9, the intermediate non-threaded shank portion defined by distance d, d′ spans an interface 110 between two timber material elements, for example an upper log 40 and a lower log 42, such that the upper log 40 in contact with the second threaded portion 22 and the lower log 42 in contact with the first threaded portion and the logs are forced together. As shown in FIGS. 9 A-E, the fastener 10 may be dimensionally scaled such that when embedded in an upper log 40, having a center line C_{L} and a lower log 42, having a center line C_{L}′, the non-threaded portion 28 spans an interface between the two logs. There are a variety of dimensions that can be advantageously varied in order to accommodate differing sized logs. For example, the effective fastener length F_{L} (defined by the distance between the tip 50 and a lower surface 92 of a washer), the upper shaft span y (present between the second threaded portion 22 and, for example, the lower surface 92 of a washer), the non-threaded dimension d, and the counter sunk dimension C_{S} may all be advantageously varied to connect the upper log 40 with the lower log 42.

In other embodiments of the present invention, off-timing of the threads results from such structural features as: different thread and flank angles; different thread pitches; and/or a different thread direction relative to the first threaded portion. For example, as shown in FIG. 5, the distance “a” between thread crests 80′ of the second threaded portion 22 is different than the distance “a” between the thread crests 80 of the first threaded portion 20. This different distance (a′ relative to a) may be the result of a thread pitch difference wherein, for example, the threads per inch of the first threaded portion 20 is less than the threads per inch of the second threaded portion 22. This difference in pitch results in the first threaded portion 20 advancing at faster rate through a timber material than the second threaded portion 22. For example, when both the first threaded portion threads 26 and the second threaded portion threads are engaged with a timber material, the first threaded portion threads 26 advance in a direction along the center axis 14, shown by the Z arrow direction in FIG. 1, at a rate faster than the second threaded portion threads 24 are configured to advance through the timber material. This differential rate results in the second threaded portion threads 24 being pulled through the timber material at the rate associated with the first threaded portion threads 26. This pulling creates a tension in the shaft 12 between the first threaded portion 20 and the second threaded portion 22. When the intermediate non-threaded, tensioned portion of the shaft 12 spans the interface between two logs, the logs are pulled together.

In one embodiment of the present invention, as shown in FIG. 1, the second threaded portion threads 24 are embedded in the interior 41 of the upper log 40 and the first threaded portion threads 26 are threadably engaged with the interior 43 of the lower log 42. For example, the second threaded portion threads 24 are embedded such that they have pulled log material previously near a top surface 38 of the upper log 40 downward in the z arrow direction.

In one embodiment of the present invention, the first threaded portion threads 26 have a greater pitch relative to the pitch of the second threaded portion threads 24.

In one embodiment of the present invention, the second threaded portion threads 24 have a reversed pitch relative to the pitch of the first threaded portion threads 26.

In one embodiment of the present invention, the second threaded portion threads 24 are a series of circumferential rings having substantially no pitch relative to the pitch of the first threaded portion threads 26.

In one embodiment of the present invention, a non-threaded tensioned portion 28 is located between the first threaded portion 20 and the second threaded portion 22.

It should be understood, that the first threaded portion 20 and the second threaded portion 22 are preferably configured such that the off-timing is limited and the off-timing of the second threaded portion threads 24 does not result in the first threaded portion threads 26 stripping the timber material with which they are engaged. For example, the tension resulting from the off-timing should not exceed the timber material interface engagement limitations of the first threaded portion threads 26. Such variables as, for example, thread pitch, thread height, flank angle, thread angle and/or threaded portion length can be utilized to achieve desirable timber material engagement.

The timber fastener, in one embodiment of the present invention, may include a drive head 30 at the head end 16 of the shaft 12. The drive head 30 includes a tool engagement portion 32. The tool engagement portion 32 may be a hex head or may be configured with a plurality of flats 33 so as to be received by a socket driving tool (not shown). The drive head 30 may also include an angular neck portion 34 designed to embed into an upper log 40. The head 30 may additionally include a lip portion 36 which extends in a substantial lateral orientation to the center axis 14 of the shaft. The lip portion 36 is configured to engage a top surface 38 of the upper log 40.

In one embodiment of the present invention, as shown in FIG. 8, the angular neck portion 34 has an angle t° in the range of about 35° to about 45°, with a preferable angle of about 40°. The angle t° operates, among other things, to provide increased resistance with a timber material as it embeds and/or to aid in aligning such things as bearing plates with the center axis 14 of the shaft. For example, as shown in FIG. 8A, a washer 190 may be retained between the lip portion 36 and the top surface 38 of the upper log 40 into which the fastener 10 is embedded (as shown in FIGS. 1 and 9). In operation, the angular neck 34 may guide the washer 90 or plate such that the center axis 14 of the shaft is in substantial alignment with an opening of the washer or plate.

In one embodiment of the present invention a bearing plate may be present between the lip portion 36 and the top surface 38 of the upper log 40. For example, a washer 90 may receive the fastener shank 12 such that when the timber fastener 10 is installed in the upper log, the lip portion 36 engages with an upper surface of the washer 90 and the lower surface of the washer is associated with the top surface 38 of the upper log 40. The bearing plate functions to distribute force exerted by the lip portion 36 over a larger surface area of the top surface 38 of the upper log 40. The optimal compressive connection may result when the head 30 engages the top surface 38, such as illustrated in FIG. 1 or 9. Counter sinking, defined by a distance C₅ (FIG. 9), of the head is not required in all applications. Typically, the compressive action increases significantly during the latter stages of driving the fastener.

In one embodiment of the present invention, the length of the fastener is sufficient to allow the first threaded portion 20 to extend into the lower log 42, while the second threaded portion is entirely present in the upper log 40. For example, the timber fastener 10 may have a length of between about 6 and about 16 inches.

The length of the timber fastener 10, in one embodiment of the present invention, may be configured to be used with logs 40, 42 having a fastener recess 44 and a locking groove 46 which is designed to accept a locking element 48 on the lower log, as shown in FIG. 1.

In one embodiment of the present invention, as shown in FIG. 8, the tip end 18 of the timber fastener 10 includes a self-drilling tip 50 which is configured to penetrate into a timber surface and which advantageously allows the first threaded portion 20 to engage the timber material as the fastener 10 is rotated, for example, in a clockwise direction shown by arrow X in FIG. 1. For example, as shown in FIG. 8, the tip 50 may have an entry angle w° in the range of about 20° to about 40°, and a preferred angle of about 30°. The entry angle w° facilitates the penetration and engagement of the fastener 10 into a substrate.

Representative dimensions, as identified in FIG. 8, for certain timber fastener 10 embodiments are set forth in Table I wherein each of the final portion threads 26 and the second portion threads 24 extend for approximately 13.00 inches with 7.3 threads per inch and wherein both threads are single lead symmetrical threads with a 45° included angle. The minimum of diameter of each of the first thread portion 20 and the second thread portion 22 is approximately 0.202 inches and the thread diameter is approximately 0.295 to 0.315 inches.

| | | | | | |
|---|---|---|---|---|---|
| L | 9.0 | 11.0 | 12.0 | 13.0 | 15.0 |
| A | .932 | 1.932 | 2.432 | 2.932 | 3.932 |
| d | 2.068 | 3.068 | 3.568 | 4.068 | 5.062 |

The dimensions in Table I are in inches.

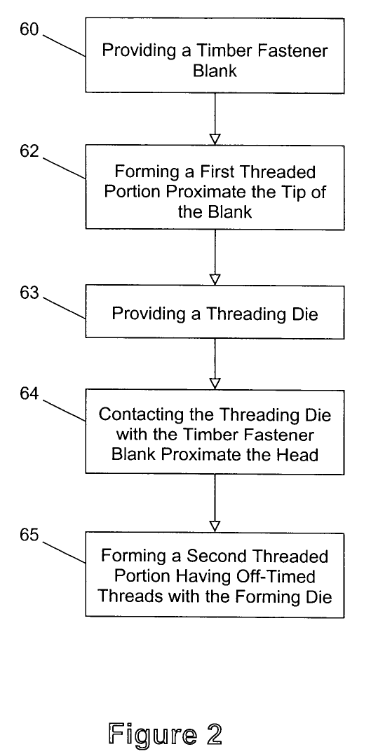

As shown in FIG. 2, one embodiment of the present invention involves a method of manufacturing a timber fastener. A fastener 10, which includes a shaft with a first threaded portion proximate a tip end and a second threaded portion having off-timed threads proximate a head end, may be produced by forming the first threaded portion and the second threaded portion in two successive threading operations. For example, the steps of forming a timber fastener may include providing a fastener blank 60 for a first thread forming operation. Such operation may include cutting, rolling, forging, or otherwise creating a thread portion 62 on the fastener blank to form a pre-threaded workpiece. A second subsequent threading operation is then accomplished by, for example, the step of providing a thread die 63 and the step of bringing the pre-threaded fastener workpiece into contact with a second thread die 64 such that the workpiece is rolled against the thread die to form the second thread 65. The orientation of the fastener workpiece to the thread die is such that a second threaded portion is formed which has off-timed threads relative to the first threaded portion is formed. In one embodiment, the upper thread 22 is formed first and the lower thread 20 second.

The second threaded portion is preferably formed such that a non-threaded interrupted portion is located between the first threaded portion and the second threaded portion. The length of the non-threaded portion can be selected by the selection of the location for the second threaded portion. For example, the length of the non-threaded portion is defined by the relationship d=x(a)+y; where “a” is a distance between adjacent thread crests 80, “x” is a whole number other than 0, and “y” is a value greater than 0 and less than a. Stated, differently d≠na where n is a positive integer (as shown in FIGS. 4 and 8).

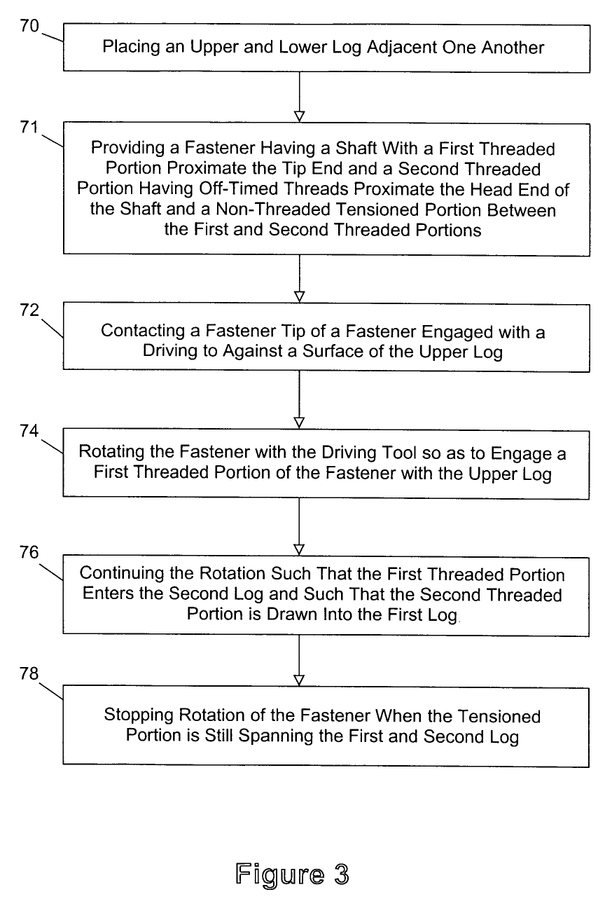

As shown in FIG. 3, one embodiment of the present invention involves a method of utilizing a timber fastener. The method includes the step 71 of providing a fastener having a shaft with a first threaded portion proximate a tip end and a second threaded portion having off-timed threads proximate a head end of the shaft and a non-threaded tensioned portion intermediate the first and second threaded portions. The method may first be carried out by placing an upper and a lower log adjacent one another at 70. The upper and lower log may have complementary grooves and ridges configured to interlock. The tip end of the timber fastener is then contacted with the upper log at 72. The timber fastener is then torqued with a tool that is operatively engaged with the head end of the shaft. Rotation of the fastener is then continued, for example in the direction of the X arrow shown in FIG. 1, so as to engage the first threaded portion of the shaft with the upper log at 74. Rotation of the fastener is further continued such that the fastener moves downward into the upper log, for example, in the direction of the Z arrow shown in FIG. 1.

As the fastener continues to be rotated, the first portion penetrates through the upper log into the lower log at 76. At or about the time the rotating first threaded portion first enters the lower log, the intermediate tensioning portion and second threaded portion with off-timed thread are drawn into an interior of the upper log. As the second threaded portion with the off-timed threads contacts the upper log material, a tensioning of the tensioned portion begins due to the off-timed threads threading into the log material at a slower rate than that of the first threaded portion threads. This disparity in the rates at which the first and second threaded portion threads move through the log interiors results in the second threaded portion being pulled through the interior of the upper log. Finally the rotation of the timber fastener is stopped when the tensioned portion is positioned in a portion of the upper log and a portion of the lower log at 78. For example, rotation can be stopped when the tensioned portion spans a distance from a point in the interior of the upper log to a point in the interior of the lower log, and when a head of the timber fastener is in contact with an upper surface of the upper log 40 as shown in FIG. 1.

In one embodiment of the present invention, as the fastener is rotated, the first threaded portion creates a thread pathway through the upper log. Continued rotation results in the first portion penetrating through the upper log into the lower log at 76. At or about the time the rotating first threaded portion first enters the lower log, the intermediate tensioning portion and second threaded portion with off-timed thread are drawn into an interior of the upper log. As the second threaded portion with the off-timed threads contacts the upper log material a tensioning of the tensioned portion begins due to the off-timed threads threading into the log material at outside the thread pathway created by the first threaded portion threads. Finally the rotation of the timber fastener is stopped when the tensioned portion is positioned in a portion of the upper log and a portion of the lower log 78.

While an embodiment of the foregoing invention has been set forth for purposes of illustration, the foregoing description should not be deemed a limitation of the invention herein. Accordingly, various modification, adaptations and alternatives may occur to one skilled in the art without departing from the spirit and the scope of the present invention.

1. A timber fastener comprising:
a shaft having a center axis, a tip end and a head end, said shaft having a first threaded portion proximate the tip end, a second threaded portion proximate the head, said second threaded portion having off-timed threads configured in off-timed rotatable relationship to the first threaded portion; and
a non-threaded portion located intermediate the first threaded portion and second threaded portion.

2. The timber fastener of claim 1, wherein a length, d, of the non-threaded portion is defined by d=x(a)+y; where a is a distance between adjacent thread crests of at least a portion of the first threaded portion, x is a whole number other than 0, and y is a value greater than 0 and less than a.

3. The timber fastener of claim 1, wherein the off-timed threads have a pitch which is less than a pitch of the first threaded portion threads.

4. The timber fastener of claim 1, further including a head associated with the head end, said head having a tool engagement surface and a lip that extends substantially laterally away from the shaft center axis.

5. The timber fastener of claim 2, wherein the head end includes a head having an angular neck and a lip.

6. The timber fastener of claim 5, wherein the angular neck has an angle of about 40°.

7. The timber fastener of claim 2, wherein the tip end includes a tip configured to penetrate and engage a substrate.

8. The timber fastener of claim 7, wherein the tip has an entry angle of about 30°.

9. The timber fastener of claim 5, wherein the head is associated with a washer.

10. A timber fastener and log assembly comprising:
an upper log having a top surface, an interior, and a bottom surface;
a lower log having a top surface in contact with the bottom surface of the upper log and an interior;
a timber fastener comprising a shaft having a center axis, a tip end and a head end, a first threaded portion proximate the tip end, a second threaded portion proximate the head end, and a non-threaded tensioned portion located intermediate the first threaded portion and the second threaded portion, said second threaded portion having threads that are off-timed relative to the first threaded portion;
wherein said second threaded portion is embedded in a portion of the upper log interior and said first threaded portion is threadably engaged with a portion of the lower log interior.

11. The timber fastener and log assembly of claim 10, wherein a length, d, of the non-threaded tensioned portion is defined by d=x(a)+y; where a is a distance between adjacent thread crests of at least a portion of the first threaded portion, x is a whole number other than 0, and y is a value greater than 0 and less than a.

12. The timber fastener and log assembly of claim 10, wherein at least part of the second threaded portion is embedded in the portion of the upper log interior which is outside of a thread pathway created by the first threaded portion.

13. The timber fastener and log assembly of claim 10, wherein the non-threaded tensioned portion is in contact with the upper log interior and the lower log interior.

14. A method of manufacturing a timber fastener comprising:
providing a timber fastener blank having opposed ends;
forming a first threaded portion proximate one end; and
subsequently forming a second threaded portion having off-timed threads relative to the first threaded portion proximate the other end such that a non-threaded portion is located between the first threaded portion and the second threaded portion.

15. The method of manufacturing a timber fastener of claim 14, further including the step of:
forming at least a portion of the second threaded portion with threading having a lesser pitch than threading on the first threaded portion.

16. The method of manufacturing a timber fastener of claim 14, further including the step of:
forming the second threaded portion such that the non-threaded portion has a length, d, wherein d is defined by d=x(a)+y; where a is a distance between adjacent thread crests of at least a portion of the first threaded portion, x is a whole number other than 0, and y is a value greater than 0 and less than a.

17. A method of joining two logs comprising:
positioning an upper log having a top surface and an interior above a lower log top having a top surface and an interior;
providing a timber fastener having a shaft, a tip end, and a head end, said shaft having a first threaded portion proximate the tip end, a second threaded portion proximate the head end having threads that are rotatably off-timed relative to the first threaded portion, and a non-threaded portion located intermediate the first threaded portion and second threaded portion;
contacting the tip with the top surface of the upper log;
rotatably driving the fastener such that the tip end engages the upper log and the first threaded portion threadably enagages the upper log interior portion;
continuing rotation such that the first threaded portion enters the interior of the lower log and the second threaded portion off-timed threads embed in the interior of the upper log; and
stopping rotation of the fastener at a position wherein the non-threaded portion is in contact with the interior of the upper log and the interior of the lower log.

18. The method of joining two logs of claim 17, wherein the step of rotatably driving the fastener such that the first threaded portion threadably enagages the upper log interior portion includes, forming a first thread pathway in the upper log; and
wherein the step of continuing rotation such that the second threaded portion off-timed threads embed in the interior of the upper log includes, forming a second thread pathway at least partially spatially distinct from the first thread pathway.
